(19) United States
(12) Patent Application Publication
(10) Pub. No.: US 2023/0385002 A1
(43) Pub. Date: Nov. 30, 2023

(54) INFORMATION PROCESSING APPARATUS, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Kaoru SAITO, SHIOJIRI-SHI (JP)

(21) Appl. No.: 18/323,692

(22) Filed: May 25, 2023

(30) Foreign Application Priority Data
May 26, 2022 (JP) 2022-085641

(51) Int. Cl. G06F 3/12; B41J 2/21

(52) U.S. Cl. CPC G06F 3/1258; G06F 3/1215; G06F 3/1208; B41J 2/2117

(57) ABSTRACT

An information processing apparatus includes a receiving unit configured to receive an input of printing conditions for each of a plurality of layers including a first layer that is the layer formed by a specific color ink and a second layer that is the layer formed by a color ink, the plurality of layers being printed to be stacked and a setting unit configured to perform processing for setting, in the first layer, an input value of the printing condition input for the first layer and processing for setting, in the second layer, the input value of the printing condition input for the second layer.

The present application is based on, and claims priority from JP Application Serial Number 2022-085641, filed May 26, 2022, the disclosure of which is hereby incorporated by reference herein in its entirety.

### BACKGROUND

### 1. Technical Field

The present disclosure relates to an information processing apparatus, an information processing method, and a non-transitory computer-readable storage medium storing a program.

### 2. Related Art

There has been a printing apparatus that prints a stacked plurality of layers including a layer formed by color ink and a layer formed by specific color ink. In the following explanation, printing the stacked plurality of layers including the layer formed by the color ink and the layer formed by the specific color ink is referred to as multilayer printing. JP-A-2009-230738 (Patent Literature 1) discloses a printing apparatus that jets a plurality of inks in designated order when printing a plurality of layers.

In the related art, in the multilayer printing, preset values of printing conditions set for an entire plurality of layers to be printed have been prepared in advance. The preset values have been collections of printing conditions for layers included in the plurality of layers. The preset values have been prepared in advance by, for example, a vendor of a printing apparatus. The setting of the printing conditions for the plurality of layers to be printed in the multilayer printing has be collectively performed on the entire plurality of layers by setting preset values selected from the preset values prepared in advance. Therefore, printing conditions other than the printing conditions indicated by the preset values prepared in advance have not been able to be set. Flexibility of setting of printing conditions has been low and convenience for a user has been low.

### SUMMARY

In view of the problems described above, an information processing apparatus includes: a receiving unit configured to receive an input of printing conditions for each of a plurality of layers including a first layer that is the layer formed by a specific color ink and a second layer that is the layer formed by a color ink, the plurality of layers being printed to be stacked; and a setting unit configured to perform processing for setting, in the first layer, an input value of the printing condition input for the first layer and processing for setting, in the second layer, the input value of the printing condition input for the second layer.

### BRIEF DESCRIPTION OF THE DRAWINGS

FIG. 1 is a diagram showing an example of configurations of an information processing apparatus and the like.

FIG. 2 is a diagram showing an overview of an example of a plurality of layers to be printed.

FIG. 3 is a diagram showing an example of an input screen.

FIG. 4 is a flowchart showing an example of registration processing.

### DESCRIPTION OF EXEMPLARY EMBODIMENTS

Embodiments of the present disclosure are explained below according to order described below.

### (1) First Embodiment

(1-1) Configuration of an information processing apparatus

(1-2) Registration processing

### (2) Second Embodiment

### (3) Third Embodiment

### (4) Fourth Embodiment

(5) Other embodiments

### (1) First Embodiment

(1-1) Configuration of an Information Processing Apparatus

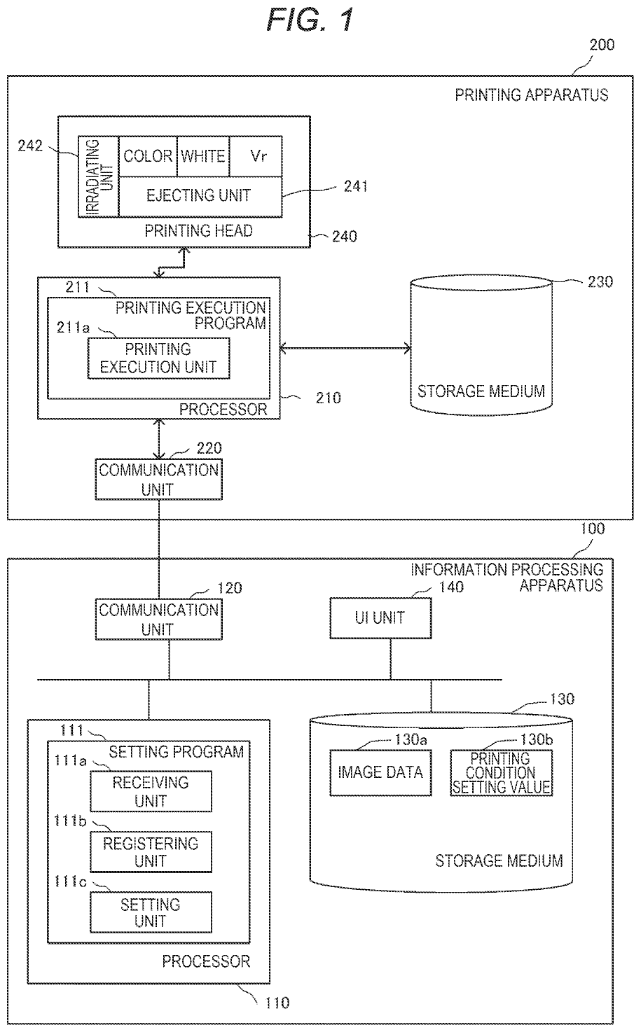

FIG. 1 is a diagram showing an example of configurations of an information processing apparatus 100 and a printing apparatus 200 according to a first embodiment. The information processing apparatus 100 in this embodiment is an information processing apparatus that controls the printing apparatus 200 and is, for example, a personal computer, a tablet apparatus, or a smartphone. The printing apparatus 200 is a printing apparatus that prints, according to an instruction from the information processing apparatus 100, an image on a printing medium (for example, a transparent or nontransparent acrylic plate, a glass plate, a medium made of resin (for example, a smartphone case made of resin), or printing paper). In this embodiment, the printing apparatus 200 performs printing on the printing medium using predetermined inks. In this embodiment, the predetermined inks are color inks (inks of colors of cyan (C), magenta (M), yellow (Y), and black (K)) and specific color inks. The specific color inks are inks used for expression of colors that cannot be expressed by the color inks and imparting of effects such as gloss and are, in this embodiment, white ink and varnish ink. The inks used by the printing apparatus 200 in this embodiment are inks that are hardened by irradiation of an ultraviolet ray. In this embodiment, it is assumed that the printing apparatus 200 is an inkjet type. However, the printing apparatus 200 may be a printing apparatus of a laser type that uses toner as ink.

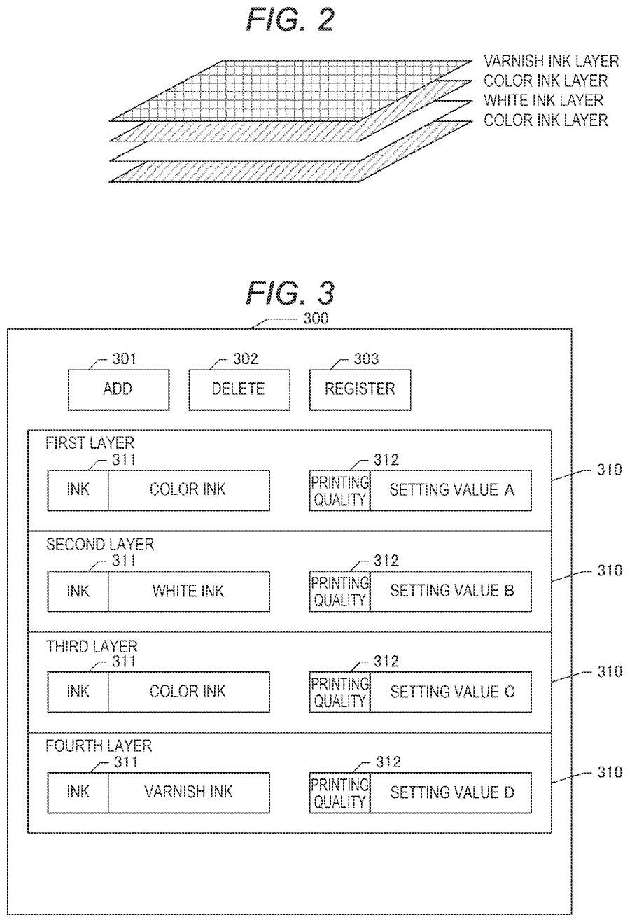

In this embodiment, the printing apparatus 200 prints a plurality of layers on a printing medium. An example of a configuration of a plurality of layers to be printed on a transparent printing medium by the printing apparatus 200 is shown in FIG. 2. In the example shown in FIG. 2, the plurality of layers are stacked, in order from the bottom, in order of a layer formed by the color ink (hereinafter, color ink layer), a layer formed by the white ink (hereinafter, white ink layer), a color ink layer, and a layer formed by the varnish ink (hereinafter, varnish ink layer). The bottom means a direction of the printing medium viewed from the layers to be printed. The color ink layer in the top layer is visually recognized from the front surface of the printing medium. The color ink layer in the bottom layer is visually recognized from the rear surface of the printing medium. In the following explanation, layers formed by the specific color inks such as the white ink and the varnish ink are referred to as specific color ink layers. Therefore, the white ink layer and the varnish ink layer are examples of the specific color ink layer.

In this embodiment, the printing apparatus 200 performs printing by ejecting ink to a printing medium and irradiating the ejected ink with an ultraviolet ray. The information processing apparatus 100 and the printing apparatus 200 are communicably connected to each other by wire or radio. The information processing apparatus 100 and the printing apparatus 200 may be integrated hardware. The printing apparatus 200 may be controlled from the information processing apparatus 100 installed in the printing apparatus 200.

Hardware included in the information processing apparatus 100 and the printing apparatus 200 is explained.

The information processing apparatus 100 includes a processor 110, a communication unit 120, a storage medium 130, and a UI unit 140. The information processing apparatus 100 includes a random access memory (RAM) and a read only memory (ROM) not shown in FIG. 1. The processor 110 executes various programs stored in the ROM, the storage medium 130, and the like to control the information processing apparatus 100. The processor 110 may be configured by a single chip or may be configured by a plurality of chips. In this embodiment, the processor 110 is assumed to be a central processing unit (CPU). However, the processor 110 may be configured by an ASIC or the like or may be configured by the CPU and the ASIC. The communication unit 120 includes a circuit used for communication conforming to wired or wireless various communication protocols between the communication unit 120 and external equipment such as the printing apparatus 200. The storage medium 130 stores various programs such as a setting program 111 for executing processing for controlling printing via the printing apparatus 200 and various kinds of information such as image data 130a and printing condition setting values 130b.

The image data 130a is data of an image of a plurality of layers to be printed. In the following explanation, the plurality of layers to be printed are referred to as printing layer. In this embodiment, data of the layers included in the image data 130a is data indicating an image to be printed. Data of a color ink layer included in the image data 130a is RGB data representing, in gradation values of RGB three channels, pixels of an image divided by a predetermined number of pixels (for example, 640×480 or 1200×1600). Data of a white ink layer and a varnish ink layer included in the image data 130a is data representing, in gradation values of one channel indicating concentration, the pixels of the image divided by the predetermined number of pixels.

The printing condition setting values 130b are preset values of printing conditions that can be collectively set for all the layers of the printing layer. The preset values are values obtained by collecting setting values of printing conditions for the layers of the printing layer. In the following explanation, the preset values are referred to as printing condition preset values. The printing conditions are conditions relating to printing and are, in this embodiment, types of inks used for formation of the layers and printing qualities of the layers. The types of the inks are a concept indicating which of the color inks, the white ink, the varnish ink, and the like the inks are. The printing qualities are parameters relating to quality of printing processing and are, for example, a media profile, a concentration value of ink, resolution of an image to be input (resolution in data of image data to be printed), parameters concerning printing speed, resolution of an image to be output (an image to be printed), a control parameter of the printing apparatus 200 concerning quality of the image to be output. In this embodiment, the parameters concerning the printing speed include the number of printing paths. The media profile is color conversion information (for example, a color conversion table) for reproducing a target color irrespective of a characteristic of a printing medium. The concentration value of the ink is an indicator value indicating concentration of the ink to be printed on the printing medium. The concentration value of the ink is used for controlling an amount of the ink ejected from a printing head 240. In this embodiment, information concerning preset values of printing quality that can be set for a single layer is stored in advance in the storage medium 130. In the following explanation, the preset values of the printing quality that can be set for the single layer are referred to as printing quality preset values.

In this embodiment, the processor 110 receives designation of a value of printing quality from a user via the UI unit 140, generates printing-quality preset values based on the designated value, and registers the generated printing-quality preset values in the storage medium 130. More specifically, the processor 110 receives, based on operation of the UI unit 140 by the user, designation of values of parameters of the printing quality (a media profile, a concentration value of ink, resolution of an image to be input, parameters concerning printing speed, resolution of an image to be output, and the like). The processor 110 collects the designated values to generate printing-quality preset values and stores the generated printing-quality preset values in the storage medium 130. The processor 110 may receive designation of values of a part of the parameters of the printing quality. In that case, for the other parameters, the processor 110 assumes that predetermined initial values are designated, generates printing-quality preset values, and stores the generated printing-quality preset values in the storage medium 130. The processor 110 may receive, based on operation of the UI unit 140 by the user, for the printing-quality preset values already generated, an instruction for update of values of a part or all of the parameters. In that case, the processor 110 updates, according to the instruction, the values of the parameters in the printing-quality preset values corresponding to the instruction. In this way, the processor 110 can improve flexibility of setting of printing quality for a single layer.

The UI unit 140 includes an input unit that receives an input from the user such as an operation unit such as a mouse, a keyboard, a touch pad, or a touch panel, a display unit such as a monitor or a touch panel, and an output unit used for presenting information to the user such as a speaker.

The printing apparatus 200 includes a processor 210, a communication unit 220, a storage medium 230, and a printing head 240. The printing apparatus 200 includes a RAM and a ROM not shown in FIG. 1. The processor 210 executes various programs stored in the ROM, the storage medium 230, and the like to control the printing apparatus 200. The processor 210 may be configured by a single chip or may be configured by a plurality of chips. In this embodiment, the processor 210 is assumed to be a CPU. However, the processor 210 may be configured by an ASIC or the like or may be configured by the CPU and the ASIC. The communication unit 220 includes a circuit used for communication conforming to wired or wireless various communication protocols between the communication unit 220 and external equipment such as the information processing apparatus 100. The storage medium 230 stores various programs such as a printing execution program 211 for controlling executing of printing and various kinds of information.

The printing head 240 performs ejection of ink to a printing medium and irradiation of an ultraviolet ray on the printing medium. The processor 210 performs the ejection of the ink to the printing medium and the irradiation of the ultraviolet ray on the printing medium while moving the printing head 240 via a driving mechanism for the printing head 240. The processor 210 repeats printing in units of a line on the printing medium via the printing head 240 to perform printing. In the following explanation, a direction of the line is referred to as main scanning direction. In the following explanation, a direction perpendicular to the main scanning direction and parallel to the printing medium disposed in the printing is referred to as sub-scanning direction. In the following explanation, printing of one line performed by the printing head 240 in printing while moving from an end to the other end of a printing region in the main scanning direction on the printing medium is referred to one printing path. The number of times of printing paths required for printing of the same region in the printing region is referred to as number of printing paths. The printing head 240 includes an ejecting unit 241 used for ejection of various inks and irradiating units 242 that perform irradiation of an ultraviolet ray on ink ejected by the ejecting unit 241. The ejecting unit 241 is a nozzle used for ejection of the inks such as the color inks (CMYK), the white ink, and the varnish ink. The ejecting unit 241 ejects the inks to the printing medium to apply the inks to the printing medium. The irradiating units 242 are lamps that are disposed on both the sides in the main scanning direction of the ejecting unit 241 and irradiate an ultraviolet ray. In the scanning of the printing head 240, the processor 210 irradiates, with the ultraviolet ray, via the irradiating units 242 located in a scanning direction rear part of the printing head 240, ink ejected to the printing medium by the ejecting unit 241.

Subsequently, functions of the information processing apparatus 100 and the printing apparatus 200 are explained.

The processor 110 of the information processing apparatus 100 executes the setting program 111 stored in the storage medium 130 to function as a receiving unit 111a, a registering unit 111b, and a setting unit 111c.

The receiving unit 111a has a function of receiving an input of printing conditions for each of the layers of the printing layer including the specific color ink layer and the color ink layer. The specific color ink layer in the printing layer is an example of the first layer. The color ink layer in the printing layer is an example of the second layer.

The processor 110 displays, with the function of the receiving unit 111a, on the UI Unit 140, a screen used for an input of a layer configuration of a plurality of layers imagined as the printing layer (hereinafter referred to as imaginary layer) and printing conditions for layers of the imaginary layer. The layer configuration is a concept indicating, in a stacked plurality of layers, a layer formed by ink of which type is stacked in which order. In this embodiment, the processor 110 displays, as the screen, an input screen 300 shown in FIG. 3. The input screen 300 includes an addition button 301 used for addition of a layer to the imaginary layer, a deletion button 302 used for deletion of a layer from the imaginary layer, and a registration button 303 used for registration of printing condition preset values.

The processor 110 sets the number of layers included in the imaginary layer based on selection of the addition button 301 and the deletion button 302. More specifically, when detecting the selection of the addition button 301 based on operation of the UI unit 140 by the user, the processor 110 assumes that one layer is added above the top layer of the imaginary layer and adds and displays an input region 310 corresponding to the added layer in the input screen 300. “Above” means “above” in the case in which a printing medium is below when viewed from a layer to be printed. When no layer is included in the imaginary layer, the processor 110 adds one layer as a layer of the bottom layer and adds and displays the input region 310 corresponding to the added layer in the input screen 300. When detecting the selection of the deletion button 302 based on operation of the UI unit 140 by the user, the processor 110 assumes that the top layer included in the imaginary layer is deleted and deletes the input region 310 corresponding to the deleted layer from the input screen 300.

That is, every time the user selects the addition button 301, the input region 310 for a layer added to the imaginary layer increases. When the user selects the deletion button 302, the input region 310 for a layer deleted from the imaginary layer decreases. An example shown in FIG. 3 indicates a situation in which four input regions 310 are displayed as a result of selecting the addition button 301 four times. In the example shown in FIG. 3, a first layer is the bottom layer, a second layer is a layer above the first layer, a third layer is a layer above the second layer, and a fourth layer is the top layer.

The input region 310 is a region used for an input of printing conditions for a layer corresponding to the input region 310 and includes input fields 311 and 312. The input field 311 is used for inputting a type of ink used for formation of a layer corresponding to the input field 311. The input field 312 is used for inputting printing quality of a layer corresponding to the input field 312.

In this embodiment, when detecting selection of the input field 311, the processor 110 presents, as a pulldown menu, choices that can be input as types of inks used for formation of a layer corresponding to the input field 311. In this embodiment, the processor 110 presents the color ink, the white ink, and the varnish ink as the choices. The processor 110 receives, via the UI unit 140, designation of ink used for the formation of the corresponding layer out of the presented choices. The processor 110 receives the ink of the designated choice as an input value of the ink used for the formation of the corresponding layer. In the example shown in FIG. 3, the color ink is input for the first layer, the white ink is input for the second layer, the color ink is input for the third layer, and the varnish ink is input for the fourth layer.

In this embodiment, when detecting selection of the input field 312, the processor 110 presents, as a pulldown menu, choices that can be input as printing qualities of a layer corresponding to the input field 312. In this embodiment, the processor 110 presents, as the choices, printing quality preset value preset values stored in the storage medium 130 (predetermined printing quality preset values and printing quality preset values generated by the processor 110). The processor 110 receives, via the UI unit 140, designation of printing quality of the corresponding layer out of the presented choices. The processor 110 receives the designated printing quality of the choice as an input value of the printing quality of the corresponding layer. In the example shown in FIG. 3, a setting value A is designated for the first layer, a setting value B is designated for the second layer, a setting value C is designated for the third layer, and a setting value D is designated for the fourth layer.

As explained above, the processor 110 receives, via the input screen 300, an input of printing conditions for each of the layers included in the imaginary layer. The input values of the printing conditions input here are set in the printing layer. That is, the processor 110 receives, via the input screen 300, an input of printing conditions for the layers of the printing layer. The processing relating to the function of the receiving unit 111a is an example of the receiving step.

The registering unit 111b has a function of registering, in the storage medium 130, the input values of the printing conditions for the layers of the imaginary layer received by the function of the receiving unit 111a as printing condition preset values that can be set in printing layer having the same layer configuration as the imaginary layer.

When detecting selection of the registration button 303 via the UI unit 140, the processor 110 performs the following processing with the function of the registering unit 111b. That is, the processor 110 registers, as printing condition preset values that can be set for the printing layer having the same layer configuration as the imaginary layer, the input values of the printing conditions for the layers of the imaginary layer input to the input fields 311 and 312 of the input regions 310 of the input screen 300 in the storage medium 130 while including the input values in the printing condition setting values 130b. More specifically, for the layers of the imaginary layer, the processor 110 determines inks input to the input fields 311 corresponding to the layers as inks used for formation of the layers and determines printing qualities input to the input fields 312 corresponding to the layers as printing qualities in printing the layers. The processor 110 registers information associating the inks and the printing qualities determined for the layers with order of stacking of the layers in the imaginary layer (indicating, for example, which layer from the bottom or which layer from the top) as printing condition preset values in the storage medium 130 while including the information in the printing condition setting values 130b.

When detecting the selection of the registration button 303, the processor 110 may receive designation of names of printing condition preset values to be registered and register the printing condition preset values in the received names.

The setting unit 111c has a function of performing processing for setting, in the specific color ink layer of the printing layer, an input value of a printing condition input for the specific color ink layer of the printing layer and processing for setting, in the second layer, an input value of the printing condition input for the color ink layer of the printing layer.

The processor 110 presents, with the function of the setting unit 111c, to the user, a printing condition preset value that can be set in the image data 130a among the printing condition preset values included in the printing condition setting values 130b. In this embodiment, the processor 110 causes the UI unit 140 to display printing condition preset values for imaginary layer having the same layer configuration as the printing layer of the image data 130a among the printing condition preset values included in the printing condition setting values 130b. When a printing condition preset value registered by the function of the registering unit 111b is selected based on operation of the UI unit 140 by the user, the processor 110 sets the printing condition preset value in the printing layer indicated by the image data 130a. That is, printing conditions for the layers indicated by the printing condition preset value are set as printing conditions for the layers of the printing layer. That is, the processor 110 sets, based on the printing condition preset value, for each of the characteristic color ink layers in the printing layer, a printing condition indicated by the printing condition preset value to be applied as a printing condition used in printing the characteristic color ink layer. For each of the color ink layers in the printing layer, the processor 110 sets a printing condition for the color ink layer indicated by the printing condition preset value to be applied as a printing condition in printing the color ink layer.

When receiving an instruction to print the printing layer indicated by the image data 130a, the processor 110 instructs the printing apparatus 200 to print the layers of the printing layer under the printing condition indicated by the printing condition preset value. At this time, the processor 110 instructs the printing apparatus 200 to print the layers in the printing layer under printing conditions (a media profile, an ink concentration value, the number of printing paths, output resolution, and the like) set for the layers in the printing layer. The processing relating to the function of the setting unit 111c is an example of the setting step.

Subsequently, a function of the printing apparatus 200 is explained.

The processor 210 of the printing apparatus 200 executes the printing execution program 211 stored in the storage medium 230 to function as a printing executing unit 211a.

The printing executing unit 211a has a function of executing printing of the printing layer on a printing medium according to an instruction of printing from the information processing apparatus 100. The processor 210 prints, with the function of the printing executing unit 211a, according to the instruction from the information processing apparatus 100, the printing layer indicated by the image data 130a on the printing medium under designated printing conditions. In this embodiment, the processor 210 prints the layers included in the printing layer on the printing medium in order from the bottom layer under the designated printing conditions to perform printing of the printing layer.

As explained above, in this embodiment, for each of the layers of the printing layer, the information processing apparatus 100 receives the input of the printing conditions and sets the received input values as the printing conditions for the printing layer. Consequently, the information processing apparatus 100 is capable of setting printing conditions desired by the user for each of the layers. That is, the information processing apparatus 100 can set printing conditions for each of the layers, improve flexibility of setting of printing conditions, and improve convenience for the user in multilayer printing. For example, when a printing condition preset value desired by the user is absent in printing condition preset values prepared in advance applicable to the printing layer, the information processing apparatus 100 can set printing conditions desired by the user by receiving an input of printing conditions individually for each of the layers of the printing layer from the user.

The information processing apparatus 100 can print, via the printing apparatus 200, the image data 130a in which registered preset values are set. The user can determine, viewing a printing result, whether image quality, printing speed, color development on the printing medium, concentration of ink, and the like are appropriate. When the user desires to change the printing conditions, the information processing apparatus 100 may receive, again, via the input screen 300, input values of printing conditions that can be set in the printing layer and register new printing condition preset values. Consequently, the information processing apparatus 100 can prepare printing condition preset values closer to the desire for the user.

When the user desires to change conditions (for example, concentration values of inks) relating to printing qualities of the layers of the printing result, the information processing apparatus 100 may perform the following. That is, the information processing apparatus 100 may receive, via the UI unit 140, a value of printing quality desired by the user and generate a new printing quality preset value. The information processing apparatus 100 may receive, via the UI unit 140, an instruction to update a parameter of the generated printing quality preset value to a value desired by the user. When receiving an input value via the input screen 300, the information processing apparatus 100 may present, again, as a choice that can be input to the input field 312, a preset value of printing quality of a single layer, a parameter of which is adjusted. Consequently, the information processing apparatus 100 can realize printing quality closer to the desire of the user.

In this embodiment, the information processing apparatus 100 registers the input values of the printing conditions input via the input screen 300 as the printing condition preset values that can be set for the printing layer having the same layer configuration as the imaginary layer. The printing condition preset values once registered are applicable many times also to different printing layers having the same layer configuration. Consequently, it is unnecessary to perform work for setting the same printing conditions again after the registration of the printing condition preset values. Convenience for the user is improved. That is, the information processing apparatus 100 can improve convenience for the user.

In this embodiment, the printing conditions include the printing quality. Consequently, the information processing apparatus 100 can set printing qualities desired by the user for the layers of the printing layer. In this embodiment, the printing quality includes the concentration value of the ink and the parameters concerning the printing speed. Consequently, the information processing apparatus 100 can set a concentration value of ink and printing speed desired by the user for the layers of the printing layer. In this embodiment, the printing conditions include the type of the ink. Consequently, the information processing apparatus 100 can set inks desired by the user as inks forming the layers of the printing layer.

(1-2) Registration Processing

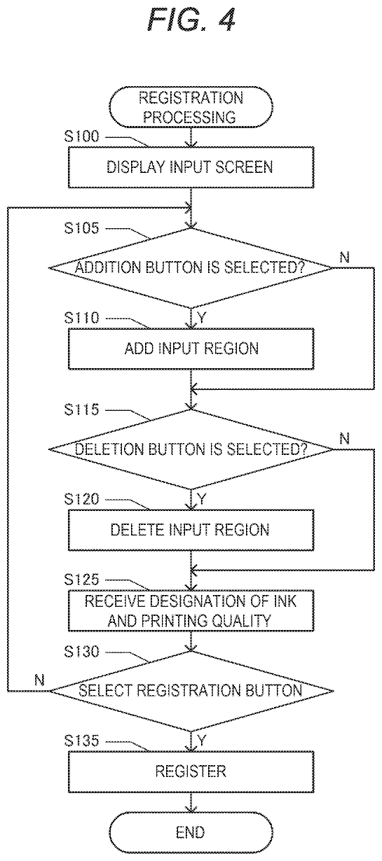

Registration processing executed by the information processing apparatus 100 is explained with reference to FIG. 4. The processor 110 starts processing shown in FIG. 4 at timing when a start of the registration processing is instructed via the UI unit 140.

In step S100, the processor 110 causes, with the function of the receiving unit 111a, the UI unit 140 to display the input screen 300. After completion of the processing in step S100, the processor 110 advances the processing to step S105.

In step S105, the processor 110 determines, with the function of the receiving unit 111a, whether selection of the addition button 301 of the input screen 300 is detected. When determining that the selection of the addition button 301 is detected, the processor 110 advances the processing to step S110. When determining that the selection of the addition button 301 is not detected, the processor 110 advances the processing to step S115.

In step S110, with the function of the receiving unit 111a, considering that one layer is added above the top layer of the imaginary layer, the processor 110 adds and displays the input region 310 corresponding to the added layer in the input screen 300. After completion of the processing in step S110, the processor 110 advances the processing to step S115.

In step S115, the processor 110 determines, with the function of the receiving unit 111a, whether selection of the deletion button 302 of the input screen 300 is detected. When determining that the selection of the deletion button 302 is detected, the processor 110 advances the processing to step S120. When determining that the selection of the deletion button 302 is not detected, the processor 110 advances the processing to step S125.

In step S120, with the function of the receiving unit 111a, considering that the top layer of the imaginary layer is deleted, the processor 110 deletes the input region 310 corresponding to the deleted layer from the input screen 300. After completion of the processing in step S120, the processor 110 advances the processing to step S125.

In step S125, the processor 110 receives, with the function of the receiving unit 111a, for the input regions 310, inputs of types of inks to the input fields 311 and inputs of printing qualities to the input fields 312. After completion of the processing in step S125, the processor 110 advances the processing to step S130.

In step S130, the processor 110 determines, with the function of the receiving unit 111a, whether selection of the registration button 303 of the input screen 300 is detected. When determining that the selection of the registration button 303 is detected, the processor 110 advances the processing to step S135. When determining that the selection of the registration button 303 is not detected, the processor 110 advances the processing to step S105.

In step S135, the processor 110 registers, with the function of the registering unit 111b, input values of printing conditions for the layers of the imaginary layer input to the input fields 311 and 312 of the input regions 310 of the input screen 300 in the storage medium 130 as printing condition preset values that can be set for the printing layer having the same layer configuration as the imaginary layer while including the input values in the printing condition setting values 130b.

### (2) Second Embodiment

In a second embodiment, processing in which, when ink used for formation of a layer is input to the input field 311 of the input region 310, the information processing apparatus 100 inputs an initial value corresponding to a type of the input ink is explained.

The information processing apparatus 100 in this embodiment is the same as the information processing apparatus 100 in the first embodiment except a function of the receiving unit 111a. The printing apparatus 200 in this embodiment is the same as the printing apparatus 200 in the first embodiment.

Processing relating to the receiving unit 111a of the information processing apparatus 100 in this embodiment is explained.

In this embodiment, when ink used for formation of a layer is input to the input field 311 of the input region 310, the processor 110 inputs, with the function of the receiving unit 111a, an initial value corresponding to a type of the input ink to the input field 312.

More specifically, when color ink is input to the input field 311, the processor 110 inputs, to the input field 312, a printing quality preset value for prioritizing image quality of a printing result (hereinafter referred to as image quality priority value) among the printing quality preset values stored in the storage medium 130. The image quality priority value is printing quality for further improving the image quality of the printing result than the other printing quality preset values. In the image quality priority value, parameters (resolution of an image to be printed, the number of printing paths, and the like) concerning the image quality of the printing result are adjusted to further improve the image quality of the printing result than the other printing quality preset values.

A viewing target image is likely to be printed on a layer formed by the color ink. The layer is requested to improve image quality compared with the layer formed by the white ink or the varnish ink. Therefore, the image quality priority value can be desired as printing quality for the layer formed by the color ink. Accordingly, when the color ink is input to the input field 311, by inputting the image quality priority value to the input field 312 as an initial value, the processor 110 can reduce time of a user for inputting the image quality priority value to the input field 312. However, the processor 110 may input another printing quality preset value to the input field 312 as the initial value.

When the varnish ink is input to the input field 311, the processor 110 inputs, to the input field 312, a printing quality preset value for prioritizing printing speed (hereinafter referred to as speed priority value) among the printing quality preset values stored in the storage medium 130. The speed priority value is printing quality for further increasing the printing speed than the other printing quality preset values. In the speed priority value, parameters (resolution of an image to be printed, the number of printing paths, and the like) concerning the printing speed are adjusted to further increase the printing speed than the other printing quality preset values.

It is assumed that the layer formed by the varnish ink is formed by solid-coating the varnish ink on a printing medium. High image quality is not requested for the layer. Therefore, it is desired to increase the printing speed in printing of the layer formed by the varnish ink. Accordingly, when the varnish ink is input to the input field 311, by inputting the speed priority value to the input field 312 as an initial value, the processor 110 can reduce time of the user for inputting the speed priority value to the input field 312. However, the processor 110 may input another printing quality preset value (for example, a standard value explained below) to the input field 312 as the initial value.

When the white ink is input to the input field 311, the processor 110 inputs, to the input field 312, a printing quality preset value for improving image quality of a printing result to a degree without unevenness (hereinafter referred to as standard value) among the printing quality preset values stored in the storage medium 130. The standard value is printing quality for improving the image quality of the printing result to a degree without unevenness in an image. In the standard value, the parameters (resolution of an image to be printed, the number of printing paths, and the like) concerning the image quality of the printing result are adjusted to a degree in which the image quality is lower than the image quality priority value, the image quality is higher than the speed priority value, and unevenness does not occur.

It is assumed that a layer formed by the white ink is formed by solid-coating the white ink on a printing medium to uniformize light transmissivity. In some case, image quality in the degree without unevenness is requested and higher image quality is not requested to the layer formed by the white ink. Accordingly, when the white ink is input to the input field 311, by inputting the standard value to the input field 312 as an initial value, the processor 110 can reduce time of the user for inputting the standard value to the input field 312. However, the processor 110 may input another printing quality preset value (the speed priority value or the like) to the input field 312 as the initial value.

As explained above, in this embodiment, the processor 110 inputs, to the input field 312, the initial value corresponding to the type of the ink input to the input field 311 of the input region 310. Consequently, when the user desires the initial value input to the input field 312, it is possible to reduce time for the input to the input field 312.

### (3) Third Embodiment

In a third embodiment, processing in which the information processing apparatus 100 inputs, to the input field 312 of the input region 310, as an initial value, a value corresponding to order of stacking of layers in an imaginary layer is explained.

The information processing apparatus 100 in this embodiment is the same as the information processing apparatus 100 in the first embodiment except a function of the receiving unit 111a. The printing apparatus 200 in this embodiment is the same as the printing apparatus 200 in the first embodiment.

Processing relating to the receiving unit 111a of the information processing apparatus 100 in this embodiment is explained.

In this embodiment, with the function of the receiving unit 111a, the processor 110 receives selection of the addition button 301 and the deletion button 302, determines the number of layers included in the imaginary layer, and displays the input regions 310 corresponding to the layers of the imaginary layer. The processor 110 receives, via the UI unit 140, for the input regions 310, inputs of types of inks to the input fields 311. The processor 110 receives, via the UI unit 140, for the input regions 310, inputs of types of inks to the input fields 311. Consequently, types of inks used for formation of the layers in the imaginary layer and order of stacking of the layers are decided.

In this embodiment, when there is a part where a white ink layer, a color ink layer, and a white ink layer are stacked in this order from the bottom in the imaginary layer, the processor 110 inputs, as an initial value, a value (a speed priority value, a standard value, or the like) different from the image quality priority value to the input field 312 of the input region 310 corresponding to the color ink layer.

The color ink layer sandwiched by the white ink layers is sometimes formed by black solid coating in order to prevent transmission of light. In such a case, high image quality is not required for the color ink layer. Accordingly, by inputting the value different from the image quality priority value to the input field 312 of the input region 310 corresponding to the color ink layer as the initial value, the processor 110 can reduce time for the input to the input field 312 by a user.

The processor 110 may perform the following. That is, for a layer that cannot be directly visually recognized from the outside in the imaginary layer, the processor 110 may input a value (the speed priority value, the standard value, or the like) different from the image quality priority value to the input field 312 of the input region 310 corresponding to the layer. Layers that can be directly visually recognized from the outside other than a varnish ink layer in the imaginary layer are two layers of a layer stacked at the top among layers different from the varnish ink layer and a layer stacked at the bottom among the layers different from the varnish ink layer when a printing medium is transparent. Therefore, when the printing medium is transparent, a layer that cannot be directly visually recognized from the outside in the imaginary layer is a layer sandwiched by the two layers. When the printing medium is not transparent, layers that cannot be directly visually recognized from the outside in the imaginary layer are layers stacked below the layer stacked at the top among the layers different from the varnish ink layer.

That is, the processor 110 may input, for each of the layers that cannot be directly visually recognized from the outside in the imaginary layer, a value different from the image quality priority value to the input field 312 of the input region 310 corresponding to the layer.

High image quality is not requested for the layer not visually recognized from the outside. Accordingly, by inputting, as an initial value, a value different from the image quality priority value to the input field 312 of the input region 310 corresponding to the layer not visually recognized from the outside, the processor 110 can reduce time for the input to the input field 312 by the user.

The processor 110 may perform the following. That is, for a predetermined number of (for example, four) layers in order from the bottom layer in the imaginary layer, the processor 110 may input the same initial value as the initial value in the second embodiment to the input fields 312 of the input region 310 corresponding to the layers. For the other layers, the processor 110 may input a value (the speed priority value, the standard value, or the like) different from the image quality priority value to the input fields 312 of the input regions 310 corresponding to the other layers.

In multilayer printing, it is more difficult to assume characteristics of a surface to which ink is applied (unevenness of the surface, a state of ink, and the like) as more layers are stacked. Therefore, when printing with a large number of layers is performed, it is sometimes desired to cause the user to set printing quality in upper layers. Accordingly, for a layer for which it is desired to urge the user to set printing quality, the processor 110 inputs a uniform printing quality preset value different from the image quality priority value to the input field 312 of the input region 310 corresponding to the layer as an initial value. Consequently, the processor 110 can indicate to the user that the layers corresponding to the input fields 312 to which the uniform initial value is input are layers for which editing of setting is urged. In the multilayer printing, when the number of layers increases, a plurality of varnishing ink layers are sometimes formed on the surfaces of the layers. Image quality is not requested for the varnishing ink layers. The user sometimes does not desire the image quality priority value as printing quality of the varnish ink layers. Therefore, for the layers other than the predetermined number of layers, in order from the bottom layer of the imaginary layer, by inputting the uniform printing quality preset value different from the image quality priority value to the input fields 312 corresponding to the layers, it is possible to reduce time for the input to the input field 312 by the user.

As explained above, in this embodiment, the processor 110 inputs, to the input field 312, an initial value corresponding to order of stacking of layers in the imaginary layer assumed as a printing layer. Consequently, when the user desires the initial value input to the input field 312, it is possible to reduce time for the input to the input field 312.

### (4) Fourth Embodiment

In a fourth embodiment, processing in which the information processing apparatus 100 changes a display form of the input region 310 according to possibility of image quality in a layer corresponding to the input region 310 being disordered is explained.

In multilayer printing, it is difficult to assume characteristics of a surface to which ink is applied (unevenness of the surface, a state of ink, and the like) in an upper layer. Therefore, possibility of image quality of a printing result being disordered is higher in a more upper layer in a printing layer. Accordingly, the processor 110 changes the input regions 310 to a predetermined display form for layers having fixed or higher possibility of image quality being disordered in an imaginary layer and presents, to a user, layers in which there is possibility of image quality being disordered.

Accordingly, in this embodiment, possibility of image quality being disordered in the imaginary layer is divided into three stages. Specifically, it is assumed that the possibility of image quality being disordered is higher in the order of first to n-th (for example, fourth) layers from the bottom, n+1-th to m-th (for example, sixth) layers from the bottom, and m+1-th and higher layers from the bottom. It is assumed that the possibility of image quality being disordered is minimum for the first to n-th (for example, fourth) layers from the bottom. For the n+1-th to m-th layers from the bottom, the processor 110 changes a display form of the input regions 310 corresponding to the layers to a display form for changing a background color to a predetermined first color (for example, blue or yellow) indicating that there is the possibility of image quality being disordered. For the m+1-th and higher layers from the bottom in the imaginary layer, the processor 110 changes a display form of the input regions 310 corresponding to the layers to a display form for changing a background color to a predetermined second color (for example, red) indicating that the possibility of image quality being disordered is higher than the possibility indicated by the first color.

The possibility of image quality being disordered in the imaginary layer may be divided into stages different from the three stages. For example, the possibility of image quality being disordered may be divided into two stages. In that case, the processor 110 may perform the following. The processor 110 may change a display form of the input regions 310 corresponding to the n+1-th and higher layers from the bottom in the imaginary layer to a display form for changing the background color to the first color.

With the configuration of this embodiment explained above, the processor 110 can present, to the user, possibility of image quality being disordered in the layers in the imaginary layer assumed as the printing layer.

### (5) Other Embodiments

The embodiments explained above are examples for carrying out the present disclosure. Various embodiments can also be adopted besides the embodiments. For example, in the embodiments explained above, the information processing apparatus 100 and the printing apparatus 200 are configured by different apparatuses. However, the information processing apparatus 100 and the printing apparatus 200 may be configured as the same apparatus. For example, the functions of the information processing apparatus 100 may be implemented in the printing apparatus 200. The information processing apparatus 100 may be configured by a plurality of apparatuses. The processing order of the flowchart of FIG. 4 may be different. For example, the order of the processing in steps S105 to S110 and the processing in steps S115 to S120 may be changed.

In the embodiments explained above, the processor 110 receives the input values of the printing conditions for the imaginary layers via the input screen 300 and registers the received input values in the storage medium 130 as the printing condition preset values. The processor 110 presents the registered printing condition preset values as the values of the printing conditions that can be set in the image data 130a and, when the printing condition preset values are selected, sets the printing condition preset values in the image data 130a.

However, the processor 110 may not register, as the printing condition preset values, the input values received via the input screen 300. In that case, for example, the processor 110 may directly set input values received via the input screen 300 in the image data 130a.

In the embodiments explained above, the color inks are the inks of the four color of cyan, magenta, yellow, and black. However, the color inks may be inks of three colors of cyan, magenta, and yellow.

In the embodiments explained above, the specific color inks are the white ink and the varnish ink. However, the specific color inks may include other inks such as fluorescent ink and metal ink.

In the embodiments explained above, the processor 110 receives, as the input values of the printing qualities of the layers of the printing layer, the designated values out of the printing quality preset values prepared in advance and the generated printing quality preset values. However, the processor 110 may receive, as the input values of the printing qualities of the layers of the printing layer, designated values out of the printing quality preset values prepared in advance or the generated printing quality preset values. For example, the processor 110 may receive, as the input values of the printing qualities of the layers of the printing layer, designated values out of the printing quality preset values prepared in advance.

Further, the present disclosure is applicable as a program to be executed by a computer and a method. The system, the program, and the method explained above are implemented as an independent apparatus in some cases and are implemented using components included in a plurality of apparatuses in other cases and include various aspects. The system, the program, and the method can be changed as appropriate; for example, a part thereof is software and a part thereof is hardware. Further, the present disclosure also can provide with a recording medium for a program for controlling the system. Naturally, the recording medium for the program may be a magnetic recording medium or may be a semiconductor memory. Any recording medium to be developed in future can be considered completely the same.

The embodiments explained above do not limit the present disclosure. Since the embodiments include a plurality of aspects having different effects, one problem and one effect read from the embodiments are not a problem and an effect for all the aspects included in the embodiments.

What is claimed is:

1. An information processing apparatus comprising:
a receiving unit configured to receive an input of printing conditions for each of a plurality of layers including a first layer that is the layer formed by a specific color ink and a second layer that is the layer formed by a color ink, the plurality of layers being printed to be stacked; and
a setting unit configured to perform processing for setting, in the first layer, an input value of the printing condition input for the first layer and processing for setting, in the second layer, the input value of the printing condition input for the second layer.

2. The information processing apparatus according to claim 1, wherein the printing conditions include printing quality.

3. The information processing apparatus according to claim 1, wherein the printing conditions include a type of ink.

4. The information processing apparatus according to claim 2, wherein the printing quality includes a concentration value indicating concentration of ink and a parameter concerning printing speed.

5. The information processing apparatus according to claim 1, further comprising a registering unit configured to register the input values of the printing conditions for each of the plurality of layers received by the receiving unit in a storage medium as preset values of the printing conditions that are set for a printing target having a same layer configuration as the plurality of layers, wherein
the setting unit sets, for the plurality of layers, the preset value selected from the preset values registered by the registering unit.

6. The information processing apparatus according to claim 2, wherein
the receiving unit receives an input of the input value of the printing quality via an input field used for an input of the input value of the printing quality for each of the plurality of layers, and
an initial value of the input field for the printing quality is a value of the printing quality corresponding to a type of ink used for formation of the layer corresponding to the input field.

7. The information processing apparatus according to claim 2, wherein
the receiving unit receives an input of the input value of the printing quality via an input field used for an input of the input value of the printing quality for each of the plurality of layers, and
an initial value of the input field for the printing quality is a value of the printing quality corresponding to order of stacking of the plurality of layers.

8. An information processing method executed by an information processing apparatus, the information processing method comprising:
a receiving step for receiving an input of printing conditions for each of a plurality of layers including a first layer that is the layer formed by a specific color ink and a second layer that is the layer formed by a color ink, the plurality of layers being printed to be stacked; and
a setting step for performing processing for setting, in the first layer, an input value of the printing condition input for the first layer and processing for setting, in the second layer, the input value of the printing condition input for the second layer.

9. A non-transitory computer-readable storage medium storing a program for causing a computer to execute:
a receiving step for receiving an input of printing conditions for each of a plurality of layers including a first layer that is the layer formed by a specific color ink and a second layer that is the layer formed by a color ink, the plurality of layers being printed to be stacked; and
a setting step for performing processing for setting, in the first layer, an input value of the printing condition input for the first layer and processing for setting, in the second layer, the input value of the printing condition input for the second layer.
